(19) United States
(12) Patent Application Publication
(10) Pub. No.: US 2005/0185404 A1
(43) Pub. Date: Aug. 25, 2005

(54) Laser pointer

(76) Inventor: Davood Khalili, Santa Clara, CA (US)

Correspondence Address: DAVOOD KHALILI, P.O. BOX 743, SANTA CLARA, CA, 95052, US

(21) Appl. No.: 10/790,437

(22) Filed: Feb. 23, 2004

(51) Int. Cl. F21K 2/00

(52) U.S. Cl. 362/259; 362/109

(57) ABSTRACT

A light-weight, low cost of maintenance laser pointer for general purpose use having a slim and short housing with safety protection plate place-able under a rotary cap enabling the apparatus to be safe when not in use. A laser module assembly for generating a laser beam with a single cell battery and an efficient voltage multiplying or voltage reduction DC to DC converter which enables use of a single cell battery. The device also allows usage of standard disposable and also variety of recharge-able batteries and provides fixed intensity output regardless of life stage of the battery.

### REFERENCES

Source: US Patent Documents

| | | |
|---|---|---|
| 2811632 | October, 1957 | Bartlett. |
| 2979602 | April, 1961 | Barnett. |
| 3963914 | June, 1976 | Browning et al. |
| 5193897 | March, 1993 | Halsey. |
| 5307253 | April, 1994 | Jehn. |
| 5335150 | August, 1994 | Huang. |
| 5343376 | August, 1994 | Huang. |
| 5617304 | April, 1997 | Huang. |
| 5697700 | December, 1997 | Huang. |
| 5747748 | May, 1998 | Zigler. |
| 5882106 | March, 1999 | Galli. |
| 5913629 | June, 1999 | Hazzard. |
| 5988832 | November, 1999 | Chen. |
| 5993026 | November, 1999 | Wu. |
| 6012823 | January, 2000 | Shiao. |
| 6231204 | May, 2001 | Lo |
| 6,575,596 | Dec. 22, 2000 | Butt, Aamir |

### BACKGROUND OF THE INVENTION

Old Designs of Laser pointers generally use either two battery cells when AAA or AA are used and in case of watch battery styles, they use 3 batteries. Some designs have used single 3 Volt cell for lightness but the batteries of that nature are relatively expensive, with shorter life and not readily available within household products, and in addition they are not recharge-able. In the former case the total size becomes too large and adds to the weight of the unit. In the later case, the batteries are not readily available and they are expensive, and in addition, because of capacity, they do not last too long. The invention presented here, allows using low cost batteries for low cost of ownership of a laser pointer, comfort due to the light weight and availability of the batteries and allows using single cell recharge-able batteries as well. The old design of laser pointers, do not address the issue of safety during non-use of the devices for accidental turning on of the units. That issue also, has been addressed by the solution presented here.

### SUMMARY OF THE INVENTION

Accordingly, the present invention provides a single cell light-weight laser pointer. The laser pointer includes a thin short hollow housing. A laser module assembly is secured within one end of the hollow housing and a battery is placed in the opposite end thereof. A power source, typically a battery and a highly efficient DC-DC voltage multiplier, is therefore contained within the hollow housing along with a switch that upon actuation enables power to flow to the laser module assembly which creates appropriate voltage to energize a laser diode and generate laser light. An additional feature of the present invention is the use of protection plate for prevention of eye damage when the laser pointer is turned on accidentally in one's pocket or during transportation. Finally, the slim low weight Single-Cell-design allows using variety of Alkaline and also rechargeable AAA or AA and easily available batteries.

### BRIEF DESCRIPTION OF THE DRAWINGS

FIG. 1 is an perspective view of a laser pointer in the present invention;

FIG. 2. is an exploded, view of the laser pointer shown in FIG. 1

FIG. 3-A is a front view of the laser shown in FIG. 1.

FIG. 3-B is a top view of the laser shown in FIG. 1.

FIG. 3-A is a side view of the laser shown in FIG. 1.

FIG. 4 shows part of the housing of laser pointer that holds DC-DC converter and the switch and the laser diode and the way power is delivered to the diode

FIG. 5. shows a block diagram of Battery and laser diode and the DC-DC converter generating the required voltage for the laser diode

FIG. 6. Shows an example of Step up DC-DC converter circuit using an integrated circuit for operation down to 0.7 volt

FIG. 7. Shows another example of DC-DC converter circuit for operation down to 0.85 volt

### DETAILED DESCRIPTION

Referring now to FIG. 1, a present invention with is shown. Externally, the features claimed here are not visible. It follows that the present invention may be used with various, other than the specific style shown herein. The device is a cylindrical tube consisting of two segments 2,6 and bottom cap 1 and a screw on top 4 with an orifice 5 to allow the laser beam pass through. A toggle switch 3 is a momentary push button switch for control of the laser light.

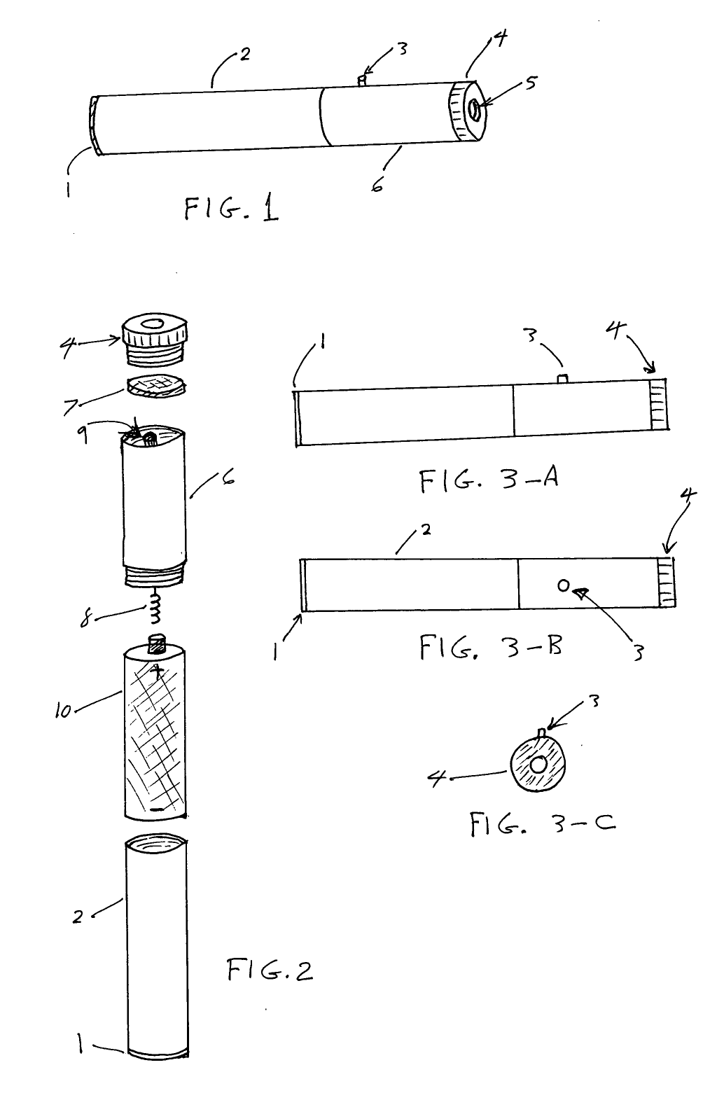

FIG. 2. shows the blown up version of FIG. 1. The laser diode sits in segment 6 of the housing and is connected to circuit/switch assembly in the housing segment 6. A spring 8 provided the connection to battery 10 on one end and to circuit board inside 6.

A circular plate 7 is used to cover the laser diode 9 when it is places under screw-on cap 4 on frond end of the laser pointer. This is taken out during normal usage and during transportation and storage, it is inserted in device to protect against accidental turning on of the device.

The battery 10 shown is a single AAA size battery and in some versions of the laser pointer it can be a similar and small with higher voltage N, L type with 6/12 Volt ratings.

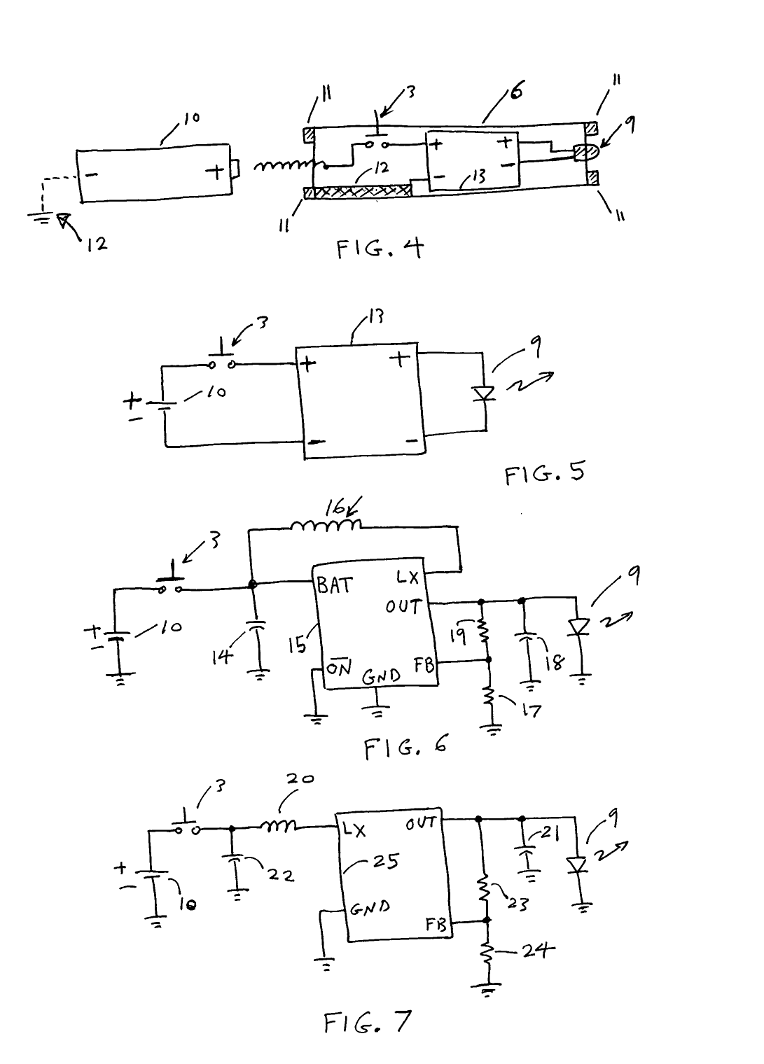

FIGS. 3A, 3B and 3C are different views front, top, and side views of FIG. 1., while, FIG. 4. shows the elements involved in providing power to the laser diode 9. a DC-DC converter module converts battery 10 voltage to the required voltage for the laser diode and gets connected to the battery 10 through spring 8. and the copper link 12 to metal O-ring 11.

The toggle switch 3 and the rest of the associated electronic circuit 13 sit in the frond section 6 of the laser tube housing.

FIG. 5. shows a block diagram of the battery 10 switch 3, DC-DC voltage converter 13 and the laser diode 9 as interconnected.

FIGS. 6 and 7 are examples of implementation of voltage conversion using integrated circuits 15 and 25 respectively. The passive component used are inductor 16, resistors 17 and 19 and capacitor 18. in FIG. 7 the circuit uses one inductor 20, A capacitor 24 at output and a capacitor 22 at input and a pair of resistors 22,23 along with the integrated circuit. There are several manufacturers of these devices and any variations of these can be built with discrete components with Integrated circuits 15 or 25 in hybrid form (using IC chips in die form or is micro or slim ouline package.

These circuits and other similar circuits can have efficiency of 95% or higher, so the maximum useful life from a single cell battery is achieved. The examples shown here are for step up DC-DC converters and similar circuits exists can be applied for step down converters when the battery voltage is high (e.g. 12 Volts).

In FIG. 6. the circuit can accept a voltage as low as 0.7 volt and that can be 0.85 for FIG. 7. These circuits can allow multiplication of voltage and getting maximum energy out of a single cell. A variation of the design using higher voltage batteries can be done by using similar circuits with step down converter integrated circuits chips using the same technology and topology in packaging and connection to the battery 10 and the laser diode 9.

Therefore the concept presented here is not limited only to 1.5-volt batteries and it can include camera type batteries with higher voltage and rechargeable batteries as well.

The construction and the shape of the laser pointer housing/packaging can be easily changed and while the usage of the concept for low cost of ownership, low weight and easily available batteries for maximum performance can be applied to all situations.

1. a laser pointer comprising:
of a laser module, a housing, a toggle switch a single-cell battery and a rotary cap and a safety protection plate, wherein:
the safety plate is used to block the laser beam during storage and transport and can easily be taken out before usage.

2. a laser pointer comprising
a single battery (AAA, N, L or similar types) with associated voltage conversion circuit (step up or step down) to provide power to the laser diode with fixed intensity of light and allow maximum usage of battery energy before its disposal/recharge.
Wherein:
2-a highly efficient DC to DC converter Circuit made from discrete components or Integrated circuits in Slim package or die form mounted on a PCB or similar assembly and housed in the laser housing described in claim 2. with an optional step down DC to DC step down converter for using small 6V-12 camera type batteries
2-b. a highly efficient circuit with 90% efficiency or over 95% in some variations of DC-DC converter chips or modules made of discrete electronic components or Integrated circuits or a hybrid module converting the battery voltage in claims 1., to appropriate value for driving the laser pointer diode where, it can work for inputs higher than 0.7 Volt.
2-c. fixed intensity output provided by claim 2., regardless of the dropped battery voltage after device operation and use, while utilizing maximum energy available from battery regardless of its life stage and of its reaching low level in voltage of 0.7 Volts.
